(19) United States
(12) Patent Application Publication
(10) Pub. No.: US 2015/0261659 A1
(43) Pub. Date: Sep. 17, 2015

(54) USABILITY TESTING OF APPLICATIONS BY ASSESSING GESTURE INPUTS

(71) Applicants: Bjoern BADER, Eppelheim (DE); Patrick FISCHER, Ludwigshafen (DE); Juergen MANGERICH, Mannheim (DE); Dietrich MAYER-ULLMANN, Invesheim (DE); Caroline SCHUSTER, Bretten (DE); Susann GRAEFF, Angelbachtal (DE)

(72) Inventors: Bjoern BADER, Eppelheim (DE); Patrick FISCHER, Ludwigshafen (DE); Juergen MANGERICH, Mannheim (DE); Dietrich MAYER-ULLMANN, Invesheim (DE); Caroline SCHUSTER, Bretten (DE); Susann GRAEFF, Angelbachtal (DE)

(21) Appl. No.: 14/207,509

(22) Filed: Mar. 12, 2014

(51) Int. Cl. G06F 11/36; G06F 3/0484; G06F 9/44; G06F 3/01

(52) U.S. Cl. CPC G06F 11/3688; G06F 3/017; G06F 3/04842; G06F 8/38; G06F 11/3664

(57) ABSTRACT

Various embodiments of systems and methods to assess gesture inputs for performing usability testing of an application are described herein. In one aspect, a GUI associated with an application to be tested is presented. Gesture inputs from test participants to invoke execution of a task of the application using the GUI are recorded. Further, 3D coordinates corresponding to each of the recorded gesture inputs are determined And, the determined 3D coordinates are assessed to determine at least one intuitive gesture input to invoke execution of the task of the application.

### BACKGROUND

The ways in which users interact with computer applications and access their varied functionality are changing dynamically. The familiar keyboard and mouse, effective tools for inputting text and choosing icons on various user interface (UI) and/or graphical user interface (GUI) types, are extended by user gesture inputs in a virtual three dimensional (3D) space. Often, users would like to communicate with applications through physical movements.

As core technologies continue to improve, a challenge for an application designer is to find out which gestures can be used to interact with the application in order to create intuitive UIs. Therefore, usability testing of such applications plays a major role for ensuring quality within a software development process. The conventional testing methods, such as trial and error, applied to determine usability can be expensive, tedious and error prone.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of a computing environment illustrating a computing system to assess gesture inputs for performing usability testing of an application, according to an embodiment.

FIG. 2 is a flow diagram illustrating a process to assess gesture inputs for performing usability testing of an application, according to an embodiment.

FIG. 3 is a schematic diagram illustrating an exemplary 3D gesture input to select an object on a graphical user interface, according to an embodiment.

FIG. 4 is a schematic diagram illustrating an exemplary 3D gesture input to select an object on a graphical user interface, according to an embodiment.

FIG. 5 is a schematic diagram illustrating an exemplary 3D gesture input to change a position of an object on a graphical user interface, according to an embodiment.

FIG. 6 is a schematic diagram illustrating an exemplary 3D gesture input to change a position of an object on a graphical user interface, according to an embodiment.

FIG. 7 is a block diagram of an exemplary computer system, according to an embodiment.

### DETAILED DESCRIPTION

Embodiments of techniques to assess gesture inputs for performing usability testing of applications are described herein. Usability testing of an application pertains to determining how ease for a user to interact with the application to access varied functionality of the application. As a result, usability testing can determine effective and efficient interaction with the application and thus improve the quality and reliability of the application. Examples for such applications can include, but are not limited to, a gaming application and a business application designed to support 3D gesture inputs for interacting with users. A gesture can be defined as a movement of part of a body to interact with a computer system such as, but not limited to 2D gesture and 3D gesture.

According to one embodiment, a number of test participants are instructed to interact with the application by performing a task through 3D gesture inputs. All events triggered by 3D gesture inputs (e.g., body movements) of a test participant, while executing the task, are recognized and recorded. Further, the recorded data is streamed (e.g., along x, y and z coordinates). The streamed data is then assessed to determine at least one intuitive 3D gesture input for accessing the task. Thus the 3D gesture inputs of the test participants are assessed for efficiency and effectiveness of the application. Further, the at least one intuitive gesture input can be associated with the application to improvise a graphical user interface for performing the task.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

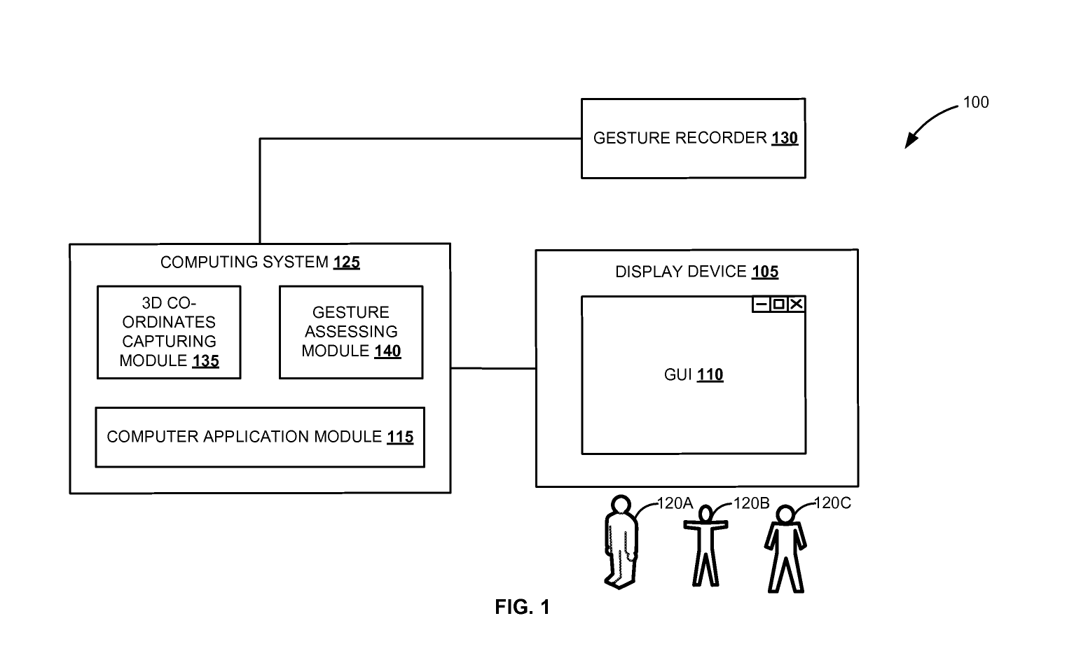

FIG. 1 is a block diagram of computing environment 100 illustrating computing system 125 to assess gesture inputs for performing usability testing of an application, according to an embodiment. The computing environment 100 includes a display device 105 displaying graphical user interface (GUI) 110 of the application to be tested (e.g., application stored in computer application module 115 of computing system 125).

The computing environment 100 also includes gesture recorder 130, i.e., a gesture recognition device, capable of recognizing and recording 3D gesture inputs of test participants (e.g., 120A, 120B and 120C) accessing the application. For example, 3D gesture inputs from a test participant (e.g., 120A, 120B or 120C) for selecting an object on the GUI 110 are recorded or captured by the gesture recorder 130. The 3D gesture inputs may include test participant's body movements such as, but not limited to, a hand gesture, a leg gesture, a face gesture, eyes gesture, a voice command or a combination thereof. For example, a hand wipe of the test participant (e.g., 120A, 120B or 120C) may be a 3D gesture input for turning a page of a virtually displayed book on the GUI 110, a hand rise may be a 3D gesture input to select an object on the GUI 110. In one exemplary embodiment, the 3D gesture inputs are recorded by scanning a skeleton or a frame corresponding to the 3D gestures such as the skeleton of a hand.

The 3D gesture inputs of different participants (120A, 120B and 120C) may or may not be similar. For example, different users find different types of 3D gesture inputs convenient to access a same functionality of the application. For example, some users may find swiping with a right hand convenient to move from one page to another, while other users may find swiping with a left hand more convenient to perform the same task. Therefore, intuitive 3D gesture inputs are determined for accessing functionalities of the application. In one embodiment, a number of test participants (e.g., 120A-120C) are instructed to invoke execution of same task (e.g., selecting an object on the GUI 110). The 3D gesture inputs of the test participants (e.g., 120A-120C) are later compared to determine at least one intuitive 3D gesture input for executing the task.

Computing system 125 includes 3D coordinates capturing module 135 to capture 3D spatial coordinates (e.g., x, y, z) of the recorded 3D gesture input. For example, the x, y, z spatial coordinates are captured by measuring starting points and ending points of the scanned skeleton corresponding to the 3D gesture inputs. Similarly, 3D coordinates of the 3D gesture inputs of the different test participants (120A-120C) are determined.

Computing system 125 further includes gesture assessing module 140 to assess the determined 3D coordinates to determine at least one intuitive 3D gesture input to invoke execution of a particular task of the application. Determining the intuitive 3D gesture input includes comparing 3D gesture inputs of different test participants (e.g., 120A-120C) and selecting an average or common 3D gesture input used to invoke execution of the task as the intuitive 3D gesture input. For example, when majority of test participants interact with the application by swiping the right hand to move from one page to another and some use left hand and one test participant interact by pointing a finger, then the intuitive 3D gesture input to move from one page to another can be swiping right hand or left hand. Further, the determined intuitive 3D gesture input can be associated to invoke execution of the task and thus optimizing or improving GUIs. Therefore, usability testing of applications offering interactions in a real 3D environment may be optimized.

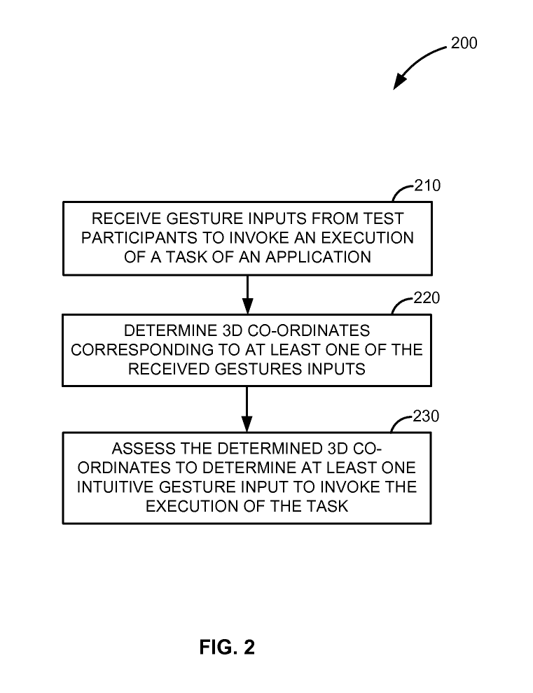

FIG. 2 is a flow diagram illustrating a process 200 to assess gesture inputs for performing usability testing of an application, according to an embodiment. A graphical user interface (GUI) associated with the application to be tested is presented to a number of test participants. At 210, gesture inputs from the test participants are received. The gesture inputs are aimed to invoke an execution of a task of the application using the GUI are received. In one exemplary embodiment, the test participants are instructed to perform same task using the GUI. Further, the 3D gesture inputs of the test participants while performing the task are recorded. The 3D gesture inputs may include, but not limited to, one or more of a hand gesture, a leg gesture, a face gesture, a body gesture, eyes gesture, a voice command and a combination thereof.

For example, the task can be selecting an object of the GUI. The selection gesture can be a forward and backward movement of a hand or finger such as, but not limited to tipping, stabbing, snapping, pulling and grabbing with two or more fingers. Further, the selected object may be foregrounded to indicate a selection such as, but not limited to a color highlighting or shape resizing. Also, the object selection can be of different types such as single-selection (e.g., selecting an object on the GUI) and multi-selection (e.g., selecting a number of objects on the GUI). In one embodiment, a voice or speech recognition may support recognizing of a selection such as saying ‘select’.

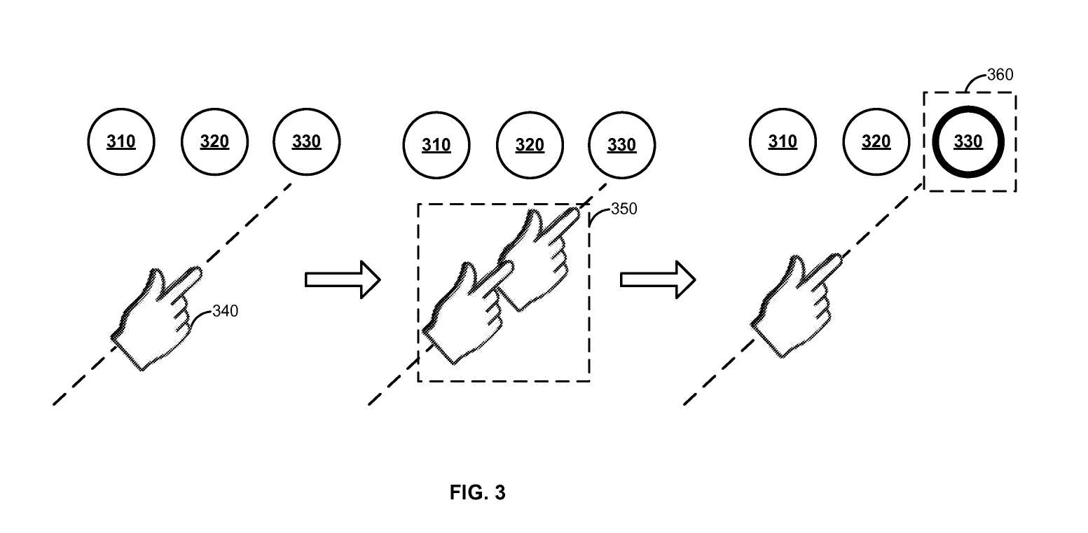

FIG. 3 is a schematic diagram illustrating an exemplary input 3D gesture of a first test participant to select an object on a GUI, according to an embodiment. In the example, three objects (e.g., 310, 320 and 330) associated with an application are displayed. The first test participant is instructed to select object 330. The first test participant focuses on the object 330 by pointing a finger towards the object 330 (e.g., 340). When focused, a change from pointing to tipping gesture (e.g., 350) triggers the selection (e.g., 360) as shown in FIG. 3. Tipping can be defined as pointing with a finger to the object and moving the finger to a direction forward and backward again (e.g., 350), the object gets a selection indicator (e.g., 360). The selection state stays until gesture is repeated on same or other object on the GUI.

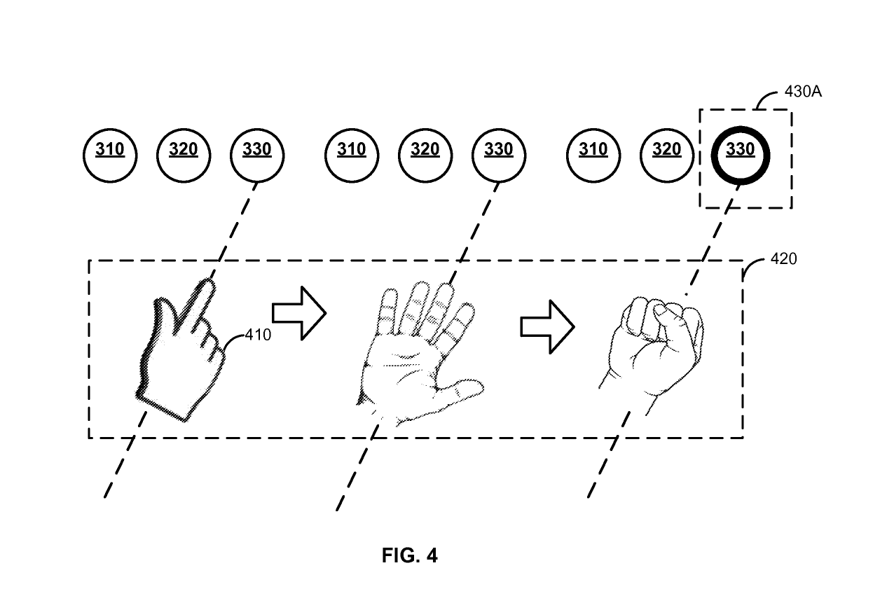

FIG. 4 is a schematic diagram illustrating an exemplary input 3D gesture of a second test participant to select an object on the GUI, according to an embodiment. The second test participant is instructed to select object 330 of displayed objects 310, 320 and 330. The second test participant focuses on the object 330 by pointing a finger towards the object 330 (e.g., 410). When focused, a change from pointing to grabbing gesture (e.g., 420) triggers the selection (e.g., 430A) as shown in FIG. 4. Grabbing can be defined as open hand goes to a fist; the object gets a selection indicator. The selection state stays until gesture is repeated on same or other object. Similarly the rest of the test participants are instructed to perform the task with same testing condition (e.g., selecting the object 330) and same testing environment to get an objective and representative result. The 3D gesture inputs of the test participants are recorded.

At 220, 3D coordinates corresponding to at least one of the received gesture inputs are determined For example, 3D coordinates for the 3D gesture inputs of FIGS. 3 and 4 can be measure of a starting point and an ending point of a point finger of a right arm of first test participant and a first of a right hand of second test participant.

At 230, the determined 3D coordinates are assessed to determine at least one intuitive gesture input to invoke execution of the task. The intuitive input gesture can be an average 3D gesture input or common 3D gesture input of the of test participants. For example, test participants interact with the application through different 3D gesture inputs as shown in FIGS. 3 and 4. Thereby, the 3D gesture inputs of the test participants are analyzed to check if there is matching 3D gesture input made for interaction steps or an average 3D gesture input is considered. Identified matches can be interpreted as the intuitive 3D gesture input for interactions done with the GUI and thus optimizing 3D GUIs.

Similarly different tasks of the application can be tested using steps 220 to 240. For example, to move an object from one point to another, a moving gesture can be performed. The moving gesture can be defined as moving the hand parallel to the GUI (e.g., GUI on projection screen) and focusing on a desired object to select. Upon selecting the object, the hand is moved parallel to the GUI and stopped at a new point on the GUI to place the selected object.

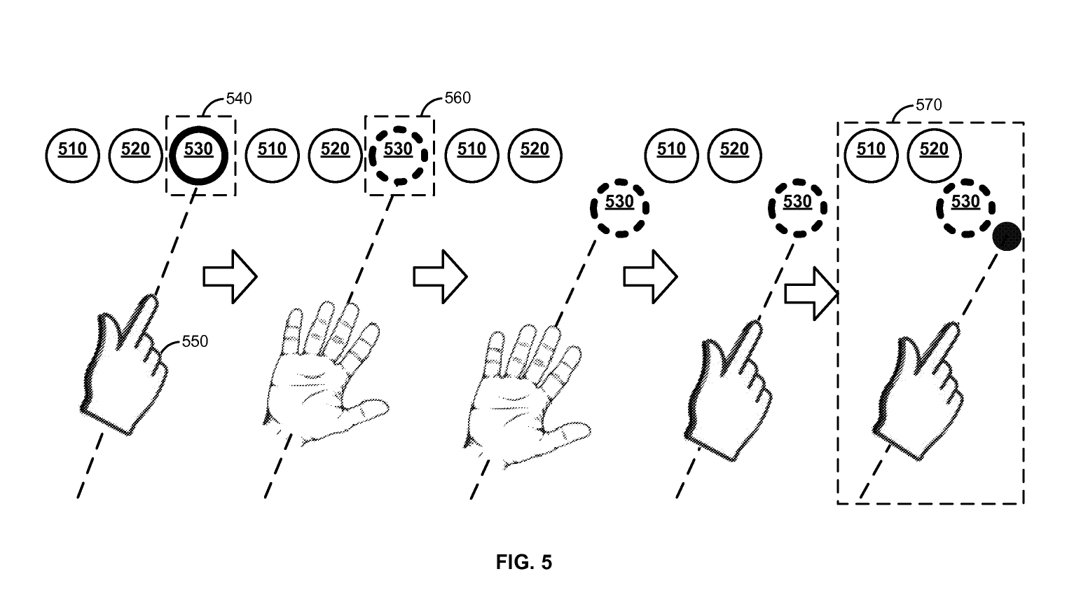

FIG. 5 is a schematic diagram illustrating an exemplary 3D gesture input to change a position of an object by a first test participant on a GUI, according to an embodiment. In the example, three objects (e.g., 510, 520 and 530) associated with an application are displayed. The first test participant is instructed to change the position of the object 530. Upon selecting (e.g., 540) the object 530 by pointing a finger (e.g., 550) at the object 530, the object 530 is focused to start the moving sequence and the object 530 gets special moving highlighting (e.g., 560) as shown in FIG. 5. After moving, the object can be released by pointing a position at which the object 530 is desired to be placed (e.g., 570).

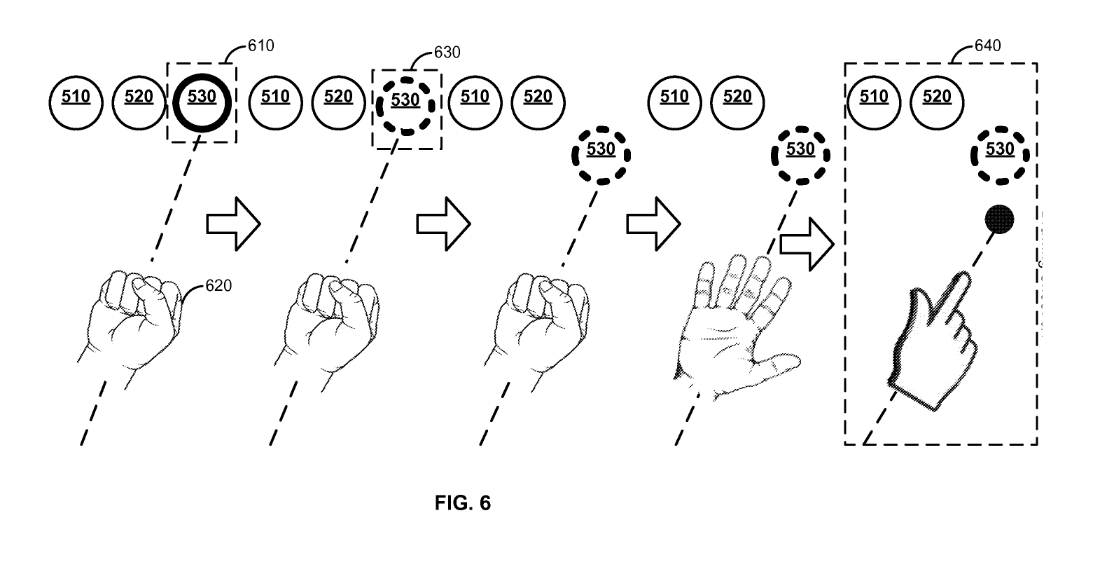

FIG. 6 is a schematic diagram illustrating an exemplary input 3D gesture to change the position of the object by a second test participant on the GUI, according to an embodiment. The second test participant is instructed to change the position of the object 530. Upon object selection (e.g., 610) by a grabbing gesture, i.e., first gesture (e.g., 620), a holding first starts the moving sequence and the object 530 gets special moving highlighting (e.g., 630). After moving, the object can be released by opening hand and pointing to a new position (e.g., 640); the moving can resemble drag and drop, for instance. The 3D gesture inputs of other test participants are recorded and then accessed to determine at least one intuitive 3D gesture input for changing the position of the object as described in steps 220 to 240.

Therefore, the application can be assessed based on how intuitive the GUI is when using 3D gesture inputs for interactions and thus the quality of the application is tested.

Further, with the process described in FIG. 2, a GUI control check can be achieved. Outcome of the usability testing can be applied in changing the GUI design of the application. For example, consider changing an object on the GUI to a button control to access a functionality of the application. Now, the button control gets replaced on the GUI by the object. The new button control may have a different visual and interaction design. With the usability testing performed with the object on the GUI, it is now able to compare the used 3D gesture inputs to find out which 3D gesture input may be the best fitting for the new button control on the GUI.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

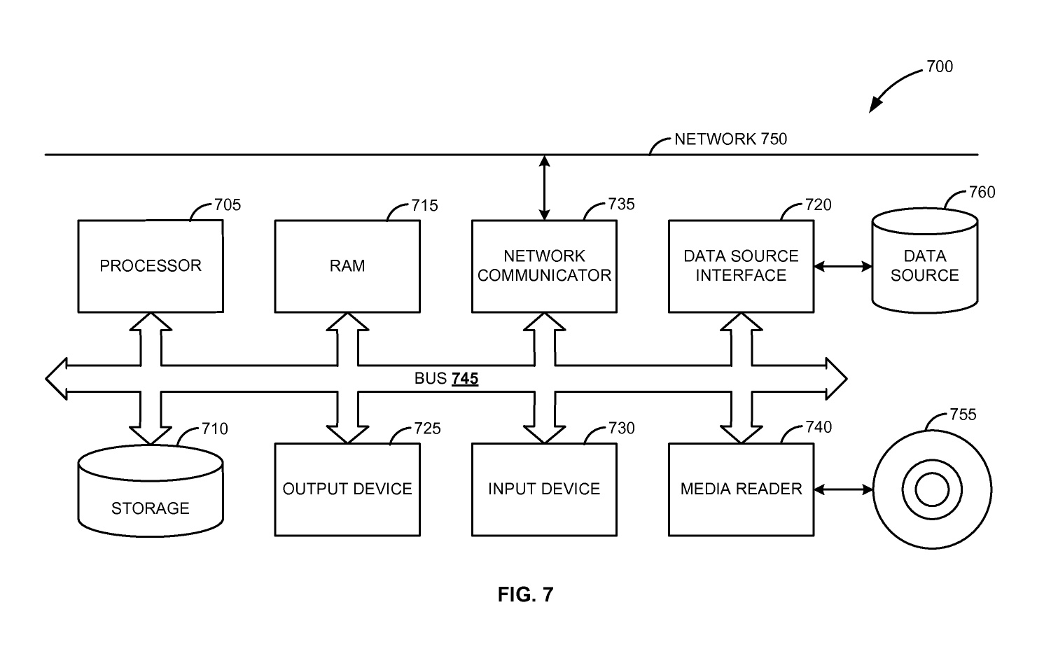

FIG. 7 is a block diagram of an exemplary computer system 700. The computer system 700 includes a processor 705 that executes software instructions or code stored on a computer readable storage medium 755 to perform the above-illustrated methods. The processor 705 can include a plurality of cores. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, all of the data required for processing may be stored in the RAM 715. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiments are described herein for illustrative purposes, various equivalent modifications are possible within the scope of the embodiments, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium storing instructions, which when executed by a computer cause the computer to perform operations comprising:
receive gesture inputs from a plurality of test participants, wherein the gesture inputs are aimed to invoke an execution of a task of an application using a graphical user interface (GUI);
determine 3D coordinates corresponding to at least one of the received gesture inputs; and
assess the determined 3D coordinates to determine at least one intuitive gesture input to invoke the execution of the task.

2. The non-transitory computer-readable medium of claim 1, further comprising instructions, which when executed cause the computer system to perform operations comprising: associating the determined at least one intuitive input gesture to invoke execution of the task.

3. The non-transitory computer-readable medium of claim 1, wherein the gesture inputs comprise one or more of a hand gesture, a leg gesture, a face gesture, a body gesture, eyes gesture and a voice command.

4. The non-transitory computer-readable medium of claim 1, wherein assessing the determined 3D coordinates comprises comparing the gesture inputs of the plurality of test participants.

5. The non-transitory computer-readable medium of claim 1, wherein the 3D coordinates are determined by measuring starting points and ending points of scanned skeletons corresponding to the received gesture inputs.

6. The non-transitory computer-readable medium of claim 1, wherein the at least one intuitive gesture input comprises an average gesture input of the received gesture inputs.

7. The non-transitory computer-readable medium of claim 1, wherein the 3D coordinates are determined using a 3D coordinates capturing module of the computer system and the determined 3D coordinates are assessed using a gesture assessing module of the computer system.

8. A computer implemented method to assess gesture inputs for performing usability testing of an application using a computer, the method comprising:
receiving the gesture inputs from a plurality of test participants, wherein the gesture inputs are aimed to invoke an execution of a task of the application using a graphical user interface (GUI);
determining 3D coordinates corresponding to at least one of the received gesture inputs; and
assessing the determined 3D coordinates to determine at least one intuitive gesture input to invoke the execution of the task.

9. The computer implemented method of claim 8, further comprising: associating the determined at least one intuitive input gesture to invoke execution of the task.

10. The computer implemented method of claim 8, wherein the gesture inputs comprise one or more of a hand gesture, a leg gesture, a face gesture, a body gesture, eyes gesture and a voice command.

11. The computer implemented method of claim 8, wherein assessing the determined 3D coordinates comprises comparing the gesture inputs of the plurality of test participants.

12. The computer implemented method of claim 8, wherein the 3D coordinates are determined by measuring starting points and ending points of scanned skeletons corresponding to the received gesture inputs.

13. The computer implemented method of claim 8, wherein the at least one intuitive gesture input comprises an average gesture input of the received gesture inputs.

14. The computer implemented method of claim 8, wherein the 3D coordinates are determined using a 3D coordinates capturing module of the computer system and the determined 3D coordinates are assessed using a gesture assessing module of the computer system.

15. A computer system to assess gesture inputs for performing usability testing of an application, the computer system comprising:
at least one processor; and
one or more memory devices communicative with the at least one processor, wherein the one or more memory devices store instructions to:
receive the gesture inputs from a plurality of test participants, wherein the gesture inputs are aimed to invoke an execution of a task of the application using a graphical user interface (GUI);
determine 3D coordinates corresponding to at least one of the received gesture inputs; and
assess the determined 3D coordinates to determine at least one intuitive gesture input to invoke the execution of the task.

16. The computer system of claim 15, further comprising: associating the determined at least one intuitive input gesture to invoke execution of the task.

17. The computer system of claim 15, wherein the gesture inputs comprise one or more of a hand gesture, a leg gesture, a face gesture, a body gesture, eyes gesture and a voice command.

18. The computer system of claim 15, wherein assessing the determined 3D coordinates comprises comparing the gesture inputs of the plurality of test participants.

19. The computer system of claim 15, wherein the at least one intuitive gesture input comprises an average gesture input of the received gesture inputs.

20. The computer system of claim 15, wherein the 3D coordinates are determined using a 3D coordinates capturing module of the computer system and the determined 3D coordinates are assessed using a gesture assessing module of the computer system.
